(19) United States
(12) Patent Application Publication
(10) Pub. No.: US 2006/0237125 A1
(43) Pub. Date: Oct. 26, 2006

(54) Method and apparatus for applying labels to documents

(76) Inventors: Bruce G. Montgomery, Mount Laural, NJ (US); Joseph C. Valinsky, Turnersville, NJ (US); Michael Nalisnik, Mount Holly, NJ (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/114,478

(22) Filed: Apr. 26, 2005

(51) Int. Cl. B65C 1/02; B65C 9/18; B65C 9/26; B32B 37/00

(52) U.S. Cl. 156/249; 156/540; 156/541; 156/542; 156/DIG. 33; 156/DIG. 37; 156/DIG. 41; 156/DIG. 2

(57) ABSTRACT

An improved apparatus and method for applying labels to documents, such as mail pieces is provided. According to one aspect, a method and apparatus are provided for applying labels to documents, wherein labels are serially peeled from a liner along the width of the liner and then transported toward a document by a label transport. The labels are conveyed along the transport so that a short side of the label is the leading edge. In addition a method and apparatus are provided wherein labels are applied by removing a first label from a web, conveying the label along a label path to a staging position and then conveying the label toward a document path where the label is adhered to a document.

### FIELD OF THE INVENTION

The present invention relates of document processing devices. More specifically, the present invention relates to the field of mail processing devices including a labeler for applying labels to mail pieces.

### BACKGROUND OF THE INVENTION

In a variety of applications, when processing mail using high speed automated machinery, it is frequently desirable to apply a label to the pieces of mail. For instance, a label may be needed to cover an incorrect label if a piece requires forwarding, or if a POSTNET bar code is improperly printed, or an area on the envelope clear of printing is required. There are a variety of devices presently available for applying labels to mail pieces, however, the known devices suffer from one of several shortcomings. For instance, certain systems are limited in the speed at which the mail pieces can be conveyed when a label is applied. Therefore, the throughput of the overall mail processing system is slowed down to accommodate the labeling limitation.

### SUMMARY OF THE INVENTION

Accordingly, to overcome the limitations of the known mail processing devices, the present invention provides an improved apparatus and method for applying labels to documents, such as mail pieces. Although the present invention is particularly suited for use in processing pieces of mail, the present invention can also be applied to a variety of document processing applications. Accordingly, the term document as used herein includes any type of document, including mail pieces, including, but not limited to post cards and envelopes containing contents.

According to one aspect, the present invention provides a device for applying labels to documents, comprising a transport for conveying documents along a transport path, a label peeler and a label transport. The label peeler is operable to serially peel the label from a liner, wherein the label is peeled along the width of the label. After the label is peeled from the liner, the label transport conveys the label to the document transport to apply the label to a document. The label transport conveys the label so that an edge other than the width of the label is the leading edge.

According to another aspect, the present invention provides a method for applying labels to documents, comprising the steps of conveying a web of labels past a label remover to remove the labels from the web, whereby the labels are removed such that a first edge of each label is the leading edge as the labels are removed from the web. The method further comprises the step of conveying a removed label along a label path, whereby a second edge of the label is the leading edge as the label is conveyed, and the step of adhering the label to a document as the document is conveyed along a document path.

In another aspect of the invention, a method for applying labels is provided, comprising the steps of providing a supply of labels on a length of web, removing a first label from the web and conveying the first label along a label path to a staging position. The label is then stopped at the staging position and subsequently advanced from the staging position toward a document path. The label is then adhered to a document as the document is conveyed along the document path.

According to yet another aspect, the invention provides a method for applying labels, comprising the steps of removing a label from a web of labels, and conveying the label along a label path. The step of conveying the label comprises the step of accelerating the label to a speed that is similar to the speed that a document is conveyed along a document path. After the label is accelerated, the label is adhered to the document traveling along the document path.

### BRIEF DESCRIPTION OF THE DRAWINGS

The foregoing summary and the following detailed description of the preferred embodiments of the present invention will be best understood when read in conjunction with the appended drawings, in which:

FIG. 1 is a side elevational view of a document processing device;

FIG. 2 is a second side elevational view of the document processing device illustrated in FIG. 1;

FIG. 3 is an enlarged side elevation view of a label remover of the device illustrated in FIG. 1;

FIG. 4 is an enlarged perspective view of a label transport of the device illustrated in FIG. 1;

FIG. 5 is an enlarged perspective view of elements of the label transport illustrated in FIG. 4;

FIG. 6 is an enlarged fragmentary plan view of a portion of the device illustrated in FIG. 1, showing the intersection of the label transport and a document transport;

FIG. 7 is a plan view of a length of web of label operable with the device illustrated in FIG. 1.

### DETAILED DESCRIPTION OF THE INVENTION

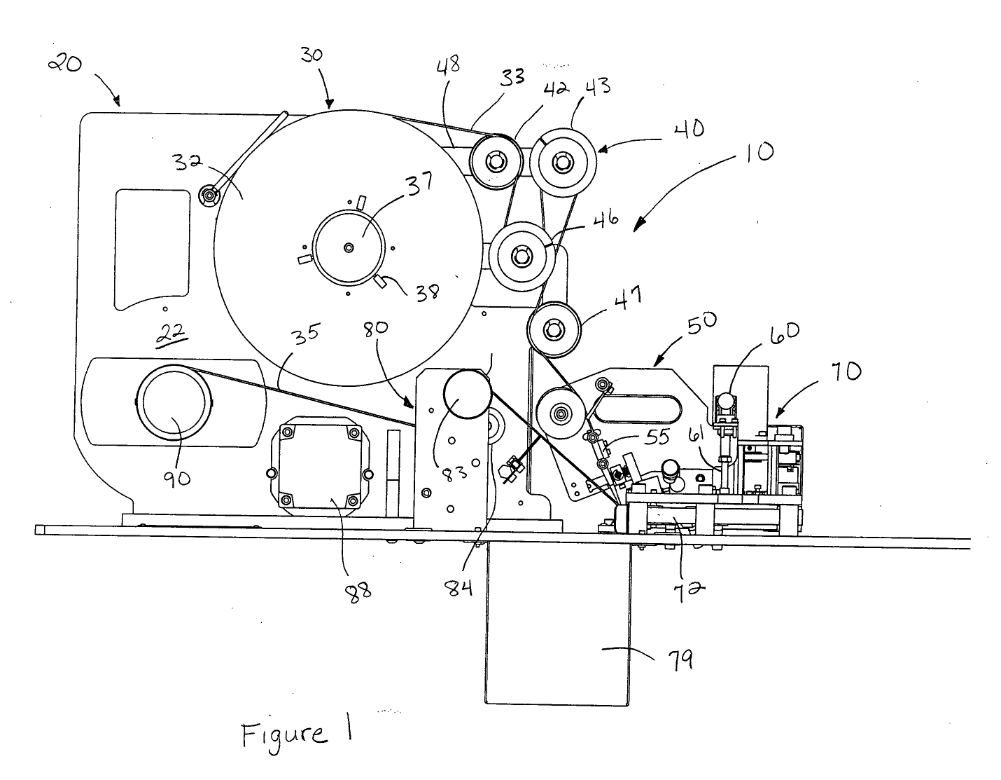

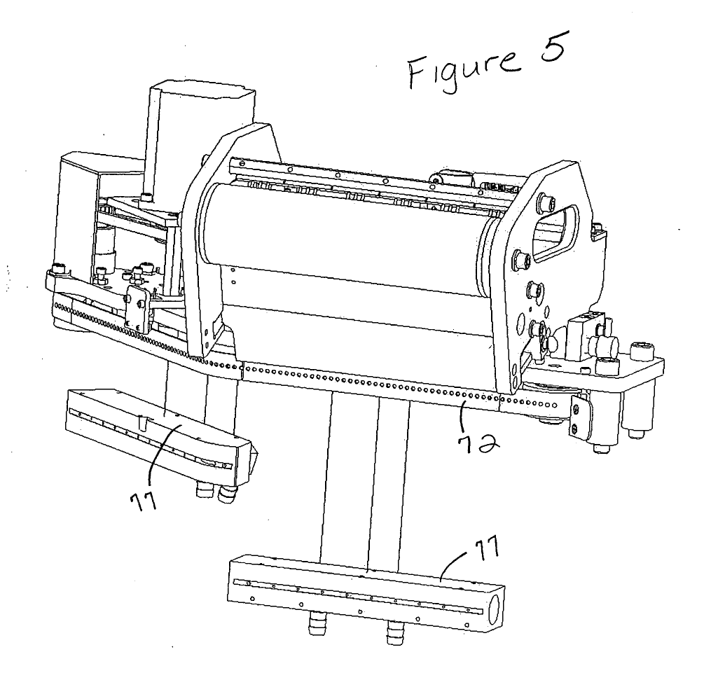

Referring now to the drawings in general and to FIGS. 1-6 specifically, a document processing apparatus is designated 10. The apparatus 10 is operable to process mail, and is particularly suited for handling mail that has been rejected from other high-speed automated processing machines. The mail is serially fed from a stack of mail to a scanner that scans the mail to identify information about the piece of mail. For instance, the scanner may scan the piece of mail to scan the address of the recipient. After the piece of mail is scanned, a label may be applied to the piece at a labeler 20. From the labeler 20, the piece may be sorted into one of a number of output bins at a sorting station.

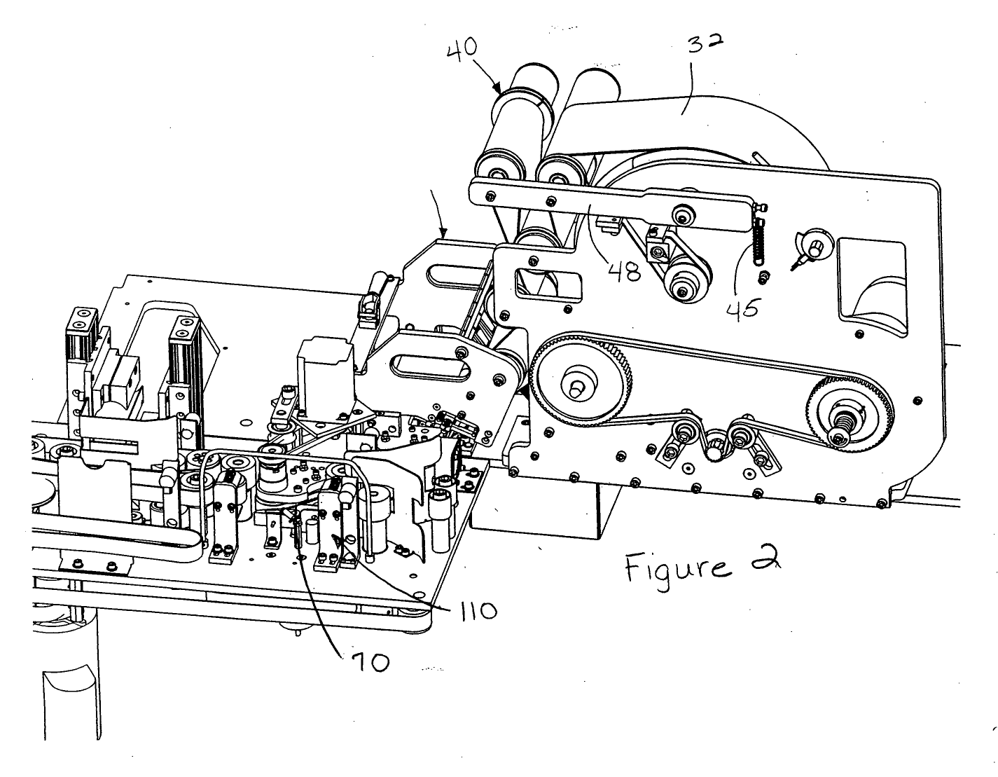

Turning now to FIGS. 1-2, the details of the labeler 20 will be discussed in greater detail. The labeler 20 is operable to remove a label from a roll of labels and convey the label to the document path so that the label can be applied to a piece of mail being conveyed along the document path. The labeler 20 includes a feeder 30 that includes a roll 32 of labels 34 adhered to a liner 35. A tensioner 40 maintains the liner in intension as the labels are fed to a label remover 50, which removes the labels from the liner. From the label remover 50, a label transport 70 conveys the removed labels to the documents path. After the labels are removed, the empty backing is wound onto a spool by a take-up system 80.

The apparatus 10 includes a system controller 120 that monitors the progress of each envelope as the envelopes are processed. The system controller tracks the sequence and location of each piece of mail, and controls various gates along the document path to control the processing of each piece of mail. The system controller receives signals from various sensors along the document path and from the various stations along the document path. The system controller controls the processing of each piece of mail in response to these signals.

Feeder

Referring now to FIGS. 1-2, the details of the feeder assembly 30 will be discussed in greater detail. The feeder 30 is configured to feed a web of labels from a roll 32. Referring to FIG. 8, the web comprises a series of labels 34 that are releasably adhered to a length of backing material or liner 35. The liner 35 may be any of a variety of materials, such as paper or plastic. In the present instance, the liner 35 is formed of clear polyester.

The labeler 20 can be utilized in connection with labels of various sizes and configurations. However, the labeler is particularly suited for use with labels that meet the U.S. Postal specifications for Letter Mail Labeling Machines, sometime referred to a LMLM standards. In the present instance, the labels have a width W that is significantly larger than the height H of the labels. For instance, the labels may be approximately 4½″-6½″ wide and approximately ⅝″ high.

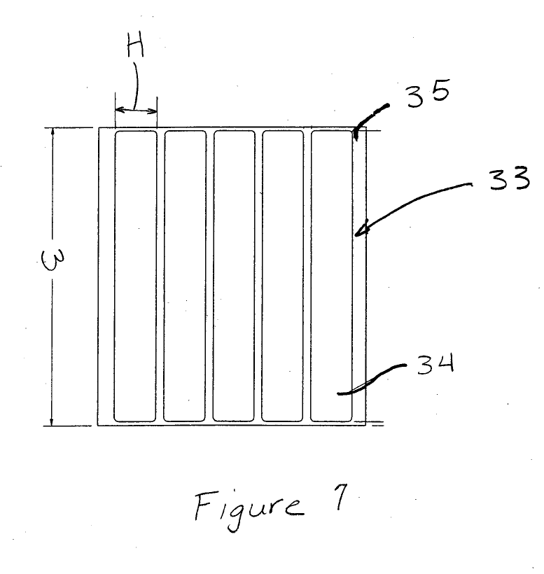

The labels 34 may be adhered to the liner 35 so that the edges of the labels are adjacent the preceding and trailing labels. However, in the present instance, there is a gap between successive labels. Further, the labels are adhered to the liner so that the width of the labels extend across the width of the liner, as shown in FIG. 7. In other words, the width-wise edges W of a first label are adjacent the width-wise edges of the preceding and trailing labels. In this way, the web of labels is rolled into a roll of labels wherein the width of each label is parallel to the axis of the roll. By spooling the labels in this orientation, a spool of labels approximately 11 inches in diameter can accommodate approximately 21,000 labels, and the web need only be advanced a distance approximating the height of the labels in order to remove a label, as discussed further below.

The feeder 30 comprises a shaft 37 configured to receive the roll 32 of labels. The roll 32 is mounted onto the shaft 37 so that the roll is rotated clockwise when the web of labels is pulled forwardly. An end cap or plate 38 attached to the shaft 37 retains the roll 32 on the shaft. The shaft 37 may be driven by a motor to advance a length of labels. However, as discussed further below, the take-up 90 is driven by a motor, so that the web 32 is pulled off of the roll 32 to advance the labels.

As discussed further below, the web is repeatedly advanced and then stopped during operation of the labeler 20. In addition, it is desirable to maintain the web under tension during use. However, when the web is stopped, the inertia of the moving roll will tend to continue to turn the roll even after the pulling force from the web stops. Accordingly, it is desirable to incorporate a brake to prevent the roll 32 from turning forwardly after the web is stopped. In the present instance, the brake comprises a friction belt that cooperates with a hub connected to the shaft 37 on which the roll 32 of labels is mounted. As discussed below, the tensioner 40 comprises a biasing arm 48. Preferably, one end of the friction belt is attached to the arm 48 so that the biasing arm biases the friction belt against the hub to brake the roll 32.

Tensioner

From the feeder 30, the web of labels passes over a tensioner 40 to retain the web in tension. The tensioner 40 comprises one or more rollers that are biased to tension the web. In the present instance, the tensioner includes two upper rollers 42, 43, that are biased away from two lower rollers 46, 47. The web 33 of labels is threaded over the first upper roller 42, then under the first lower roller 46. From the first lower roller, the web extends upwardly, passing over the second upper roller 43, which it passes over. The web then extends downwardly under the second lower roller 46 toward the label remover 50.

The two lower rollers 46, 47 are mounted on the vertical plate 22 so that the roller are fixed against vertical displacement. In contrast, the two upper rollers 42, 43 are vertically displaceable. Specifically, upper rollers 42, 43 are mounted onto a biasing arm 48 that is pivotably connected to the vertical plate 22. The upper rollers 42, 43 are connected to a first end of the arm, and a spring 45 is connected to a second end of the arm. The spring 45 biases the first end of the arm downwardly, which in turn, biases the second end of the arm upwardly, along with the roller 42, 43. In this way, the upper roller 42, 43 are biased upwardly, away from the lower rollers 46, 47. Accordingly, slack in the web is taken up by the upper roller 42, 43 pivoting upwardly to maintain the web under tension.

Label Remover

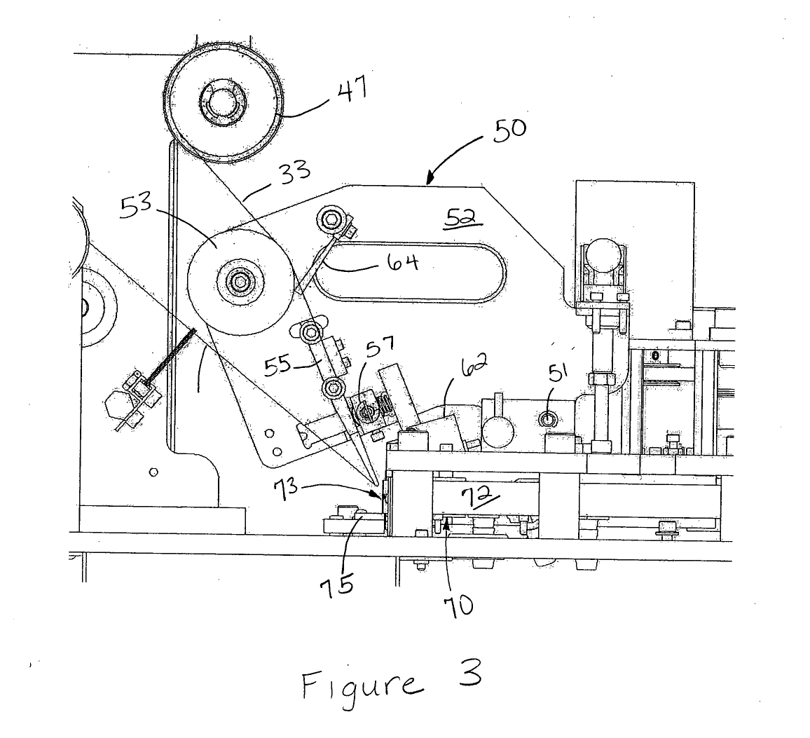

Referring to FIGS. 1 and 3, the label remover 50 is operable to remove the labels 34 from the liner 35 so that the labels can be applied to documents. The label remover 50 operates by peeling the labels off of the liner. As discussed further below, the peeling operation is accomplished by passing the web 33 over a peel plate 55, which progressively peels each label off of the liner.

The label remover 50 comprises an entry roller 53 that extends between a pair of end plates 52. Below the entry roller 53 is the peel plate 55, which is a substantially flat plate extending between the end plate 52. The peel plate 55 is positioned so that the plate projects toward label transport 70 at an angle so that the lower edge of the peel plate is adjacent the label transport. A hold down roller 57 is positioned adjacent the top face of the peel plate 55, and is biased downwardly into contact to hold the web down against the peel plate.

In the present instance, the label remover 50 is pivotable so that the web 33 can be more easily threaded through the label remover prior to use. Specifically, the label remover 50 comprises a shaft 51 that is mounted between two mounting brackets that are fixed in place. The end plates 52, along with the peel plate 55 and roller 53, 57, pivot about the shaft 51.

During use, it is desirable to lock the label remover in place to impede upward displacement, which could produce slack in the web adjacent the peel plate, thereby hampering the label removal. Accordingly, the label remover 50 includes a lock 60 for locking the label remover against pivotable motion. The lock may be in any of a number of configurations. In the present instance, the lock 60 is a toggle clamp having a plunger 61 that is vertically displaceable. In the retracted position, the label remover may be pivoted by lifting the peel plate upwardly, which in turn pivots the plunger downwardly. In the retracted position, the plunger is sufficiently spaced from the surface below so that the peel plate can be lifted a sufficient distance before the plunger engages the surface below. The lock 60 is locked by pivoting the toggle clamp, which in turn extends the plunger 61 downwardly. When the plunger 61 is extended, the plunger engages a surface below the lock. Since the plunger 61 engages the surface, the plunger cannot be displaced downwardly by lifting the peeler plate. In this way, the lock 60 is operable between an unlocked position in which the peel plate can be displaced relative to the label transport 70, and a locked position in which the peel plate cannot be displaced away from the label transport.

The labels 34 are removed from the liner 35 by pulling the web 33 over the lower edge of the label peeler 55. Preferably, the lower end of the peel plate has a sharp corner forming a sharp lower edge used to peel the labels. The web 33 passes over the entry roller 53 and under the hold down roller 57, which holds the web against the top surface of the peel plate. The web 33 then passes over the lower edge of the peel plate, and back upwardly toward rollers in the take-up section. By maintaining the web 33 in tension, the web is pulled against the sharp lower edge of the peel plate. Since the liner 35 is continuous, the liner is retained in tension around the lower edge of the peel plate 55. However, the labels 34 are not. As the leading edge of a label 34 passes the lower edge of the peel plate 55, the leading edge separates from the liner, rather than turning around the edge, as the liner does. As the liner 35 continues to be pulled around the lower edge of the peel plate, the label 34 progressively separates, or peels, from the liner. When the trailing edge of the label passes the lower edge of the peel plate, the label completely releases from the liner. The removed label is then entrained by the label transport 70, as discussed further below.

The label remover 50 also includes a sensor 62 for detecting the position of a label as it passes through the label remover. The sensor 62 is a reflective sensor that is operable to detect the leading and/or trailing edges of each label to determine the length of web that is to be advanced to advance a label past the lower edge of the peel plate. In addition, the label remover 50 comprises a plurality of brushes 64 that engage the web as the web passes through the label remover. The brushes 64 are operable to diffuse static electricity that may build up on the liner 35.

As described previously, in the present instance the labels are positioned on the web so that the width of the labels extends across the width of the liner 35, as shown in FIG. 7. Therefore, the labels are advanced toward the lower edge of the peel plate so that the width of the label is parallel to the lower edge of the peel plate, and the leading edge of the label is a width-wise edge W that is transverse the direction of travel of the web. In other words, one of the longest edges of the label is the leading edge and it is parallel to the lower edge of the peel plate. In this way, the label is progressively peeled across the entire length of the side W, and once the leading edge of a label begins to peel, the label can be removed from the liner by advancing the web a distance equal to approximately the height H of the label. For example, in the present instance, a label can be removed by advancing the web approximately ⅝″.

Take-up Assembly

After the labels 34 are removed from the liner, the liner is wound into a roll by the take-up assembly 80. The take-up assembly performs two functions. The take-up assembly winds the empty liner onto a take-up spool after the labels are removed. In addition, the take-up assembly operates to pull the liner though the labeler. In other words, the take-up assembly 80 operates as the drive control for the web, providing the driving force for the web as the web advances through the labeler.

Turning first to the drive control aspect, the take-up assembly comprises a tight nip formed between two rollers 82, 84 that project generally horizontally. One of the rollers 82, 84 is a high friction roller, and the roller are biased toward one another to form a tight nip. The liner 35 extends over the top of the first take-up roller 82, then downwardly, wrapping under the second take-up roller 84, and finally, over the top of the take-up spool 90.

The tight nip formed by the two take-up roller 82, 84 is operable to frictionally engage the liner with sufficient grip to pull the liner through the tight nip. In addition, the grip at the tight nip is sufficient to overcome the load from the drag of the liner through the label remover 50 and the tensioner 40, as well as overcoming the inertia of the roll to pull the web off of the roll.

One or both of the rollers 82, 84 is driven by a motor 88. In the present instance, the motor 88 is a stepper motor so that the displacement of the take-up rollers can be precisely controlled, thereby precisely controlling the displacement of the liner 35, as discussed further below. The motor 88 rotates one or both of the take-up rollers. As the rollers 82, 84 turn, the rollers pull the liner through the tight nip, which in turn advances the web from the roll 32 of labels 34 on the feeder 30. By using a pulling force from the take-up roller 82, 84, the web/liner is more readily maintained in tension.

The motor 88 also drives the take-up spool 90, so that when the motor drives the rollers 82, 84 to pull the liner through the tight nip, the motor turns the spool to wind up the liner. In the present instance, the power transfer to the spool is controlled so that the spool rotates faster than the rollers 82, 84. Turning the spool 90 faster than the take-up rollers 82 and/or 84 ensures that the liner is maintained in tension. A clutching mechanism allows the spool to rotate freely if the spool is rotated but there is no slack in the liner to wind up. As the liner 35 is pulled onto the spool, the liner is wound around the spool 90 to create a roll of empty liner. After the entire roll 32 of labels is used, the roll of liner 35 is removed from the take-up spool 90.

Label Transport

As described previously, the label remover 50 is operable to serially peel labels from the web 33 so that each label is separated from the liner 35 adjacent the label transport 70. Referring to FIGS. 3-6, the label transport 70 is operable to transport the removed label to the document path 110, where the label is applied to a document.

The label transport comprises a vacuum belt that is operable to apply vacuum to the label to retain the label against the belt as the label is conveyed along the label transport. As a label 34 is peeled off of the liner 35 a vacuum pulls the label up against the belt 72. Subsequently, the belt conveys the label toward the document path.

The vacuum belt 72 is a conveyor belt having a plurality of perforations. The vacuum belt rides against a manifold 77 having a plurality of ports that distribute the vacuum along the length of the label transport. The belt is entrained around the manifold so that the belt confronts the manifold along the length of the label path. Specifically, the vacuum belt 72 rides against a face of the manifold along the length of the label path. The belt may be perforated in a number of different configurations. In the present instance, the belt comprises a single row of perforation extending along the length of the belt.

The vacuum belt rides against the front face of the manifold 77, which is generally flat so that the vacuum belt can lie flat against the manifold. The manifold includes a row of ports through the front face. The row of ports are positioned so that the ports are generally aligned with the perforations in the belt when the belt is entrained about the manifold. Optionally, the front face of the manifold 77 comprises an elongated recess aligned with the row of ports. In this way, when the belt lies against the front face of the manifold, the belt and the recess form a plenum so that the vacuum from the ports is dispersed throughout the plenum along the front face of the manifold. In addition, the perforations in the belt are configured so that the perforations align with the plenum. By distributing the vacuum throughout the plenum, a generally constant vacuum is applied to the labels through the perforated belt as the belt travels along the label transport.

Optionally, the label transport 70 may include a guide rail 75 for supporting the label when it falls from the peel plate. The guide rail 75 projects outwardly from the manifold and provides a generally horizontal surface along the length of the loading area 73 adjacent the peel plate. To prevent the lower edge of the label from adhering to the guide rail, the guide rail is formed of a low friction material, such as Teflon. The guide rail 75 operates as a stop or justifier so that the bottom edge of the label is positioned at a predetermined position. In addition, the guide rail can be adjusted vertically, so that the vertical position at which the label is applied to a document can be varied by adjusting the height of the guide bar 75.

The label transport 70 may be configured so that it only accommodates a single label at the time. In such a configuration, the label transport conveys the label directly from the peeler to the document transport. However, in the present instance, the label transport 70 is configured to accommodate two labels at a time, as discussed further below.

The label transport 70 comprises a loading area 73 adjacent the label remover 50. Specifically, the loading area 73 is positioned adjacent the lower edge of the peel plate. Therefore, as a label 34 separates from the liner 35, the vacuum from the vacuum belt 72 pulls the label up against the belt.

The label transport 70 also includes a staging area 74 positioned downstream from the loading area. The staging area is configured to accommodate a label while another label is being loaded onto the belt 72 at the loading area 73. Accordingly, the staging area 73 is sufficiently spaced from the loading area to ensure that a label being loaded onto the belt 72 at the loading area does not overlap a label in the staging area 74. In addition, the staging area is positioned adjacent the document path so that a label is positioned adjacent the document path, ready to be applied to a document on the document path when necessary. A sensor 76 in the staging area 74 is operable to detect the label as it is conveyed to the staging area. The staging sensor 76 is operable to detect the leading edge and/or the trailing edge of a label as the label enters the staging area, and when the label exits the staging area.

The manifold 77 may be formed of one or more air chambers. In the present instance, the manifold includes two separate air chambers. The first air chamber is a first vacuum block that extends along the length of the label loading area 73. The second air chamber is a second vacuum block that extends along the length of the staging area 74. Each vacuum block includes one or more air fittings for connecting the vacuum blocks to a vacuum pump. In the present instance each vacuum block is connected to the vacuum pump via two vacuum lines.

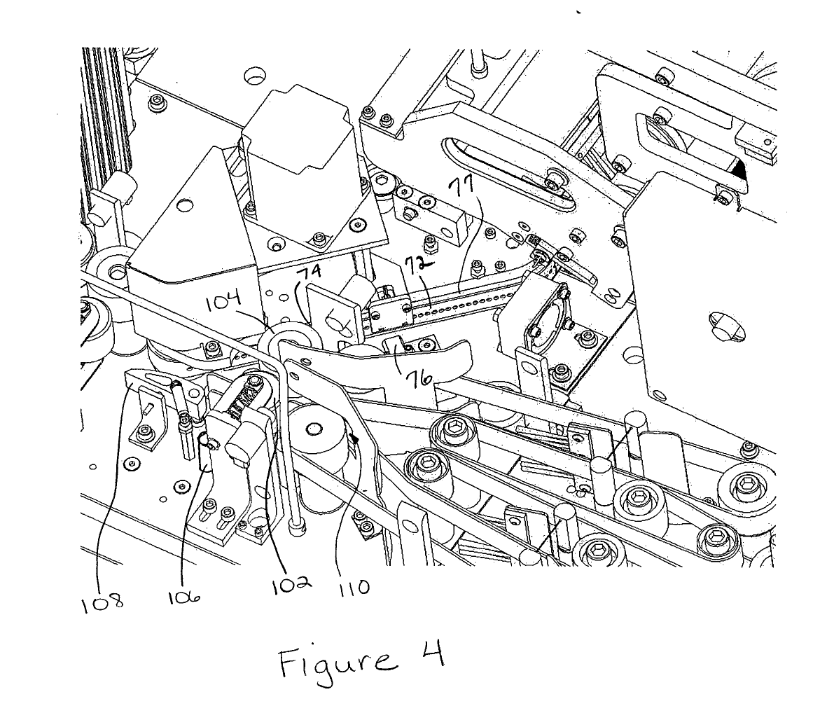

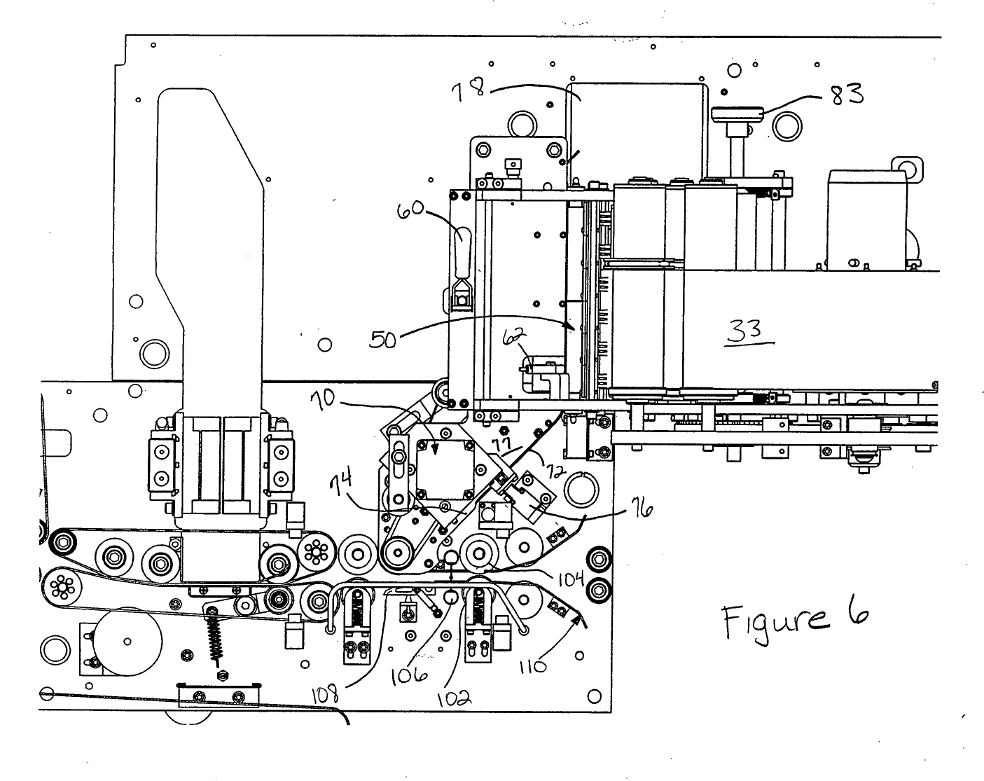

Referring to FIGS. 4, 6, the intersection between the document transport 110 and the label transport 70 can be seen. The document transport 110 comprises opposing rollers 102, 104 that convey the documents along the document path. A sensor 106 positioned downstream from the rollers 102, 104 is operable to detect the leading edge and/or the trailing edge of a document as the document passes the sensor. Downstream from the sensor 106 is a pivoting guide 108 at the intersection of the document transport and the label transport. The guide 108 is pivotable between a retracted position in which the guide is pulled away from the label transport and an extended position in which the guide is pivoted toward the label transport. In the extended position, the guide directs the document against the end of the label transport, so that the document intersects the label transport to contact the label on the end of the label transport. As the document is conveyed forwardly, the label on the end of the label transport is also conveyed forwardly, so that the label is progressively applied to the length of the document.

If the label and the document are moving at different speeds, the label may not be properly applied to document. Accordingly, it is desirable to control the speed of the label transport and the document transport so that the label and document are moving at approximately the same speed when the two intersect. Specifically, in the present instance, the document transport conveys the documents at approximately 75 inches per second. As mentioned above, at the staging area 74, the label is stationary. From this stationary position, the label transport accelerates the label so that the label is conveyed at approximately 75 inches per second when the label intersects the document path.

Method of Use

Configured as discussed above, the device operates as follows. In one mode of operation, a label is applied to every document. In a second mode of operation, the labels are selectively applied. For instance, the document may be scanned to determine if a bar code is readable. If the bar code is not readable, the document is tagged as requiring a label, and a label is applied at the labeling station 20.

Prior to use, a roll of labels 32 is mounted onto the shaft 37 of the feeder 30 and the end cap 38 is the mounted onto the shaft to retain the roll on the shaft. The web 33 is fed through the tensioner 40, label remover 50 and take-up section 80, and then attached to the take-up spool 90. When feeding the web 33 through the take-up section 80, the web cannot be manually fed between the tight nip roller 82, 84. Instead, the web is placed into the nip of the rollers 82, 84 and the hand wheel 83 is turned by hand, which rotates the nip rollers, thereby pulling the web through the rollers.

The labels 34 are fed as follows. The web is advanced by the motor 88 that drives the tight nip, which pulls the web. The sensor 62 in the label remover 50 monitor the labels as the web is advanced. Specifically, the sensor 62 is a reflective sensor that monitor the leading edge of a label in the label remover and the trailing edge. After the sensor detects the trailing edge of the label, the sensor sends a signal to the controller 120 indicating that the trailing edge has passed. In response to the signals received from the sensor, the controller controls the operation of the motor 88 so that the web continues to advance until the trailing edge passes the sensor. The web is then advanced a further amount based on the gap between adjacent labels.

As the web is advanced, the label adjacent the bottom edge of the peel plate is peeled from the web, so that the label is released from the liner. As the label is released, the lower edge of the label falls onto the guide rail 75 and the vacuum of the vacuum belt 72 pulls the front face of the label (i.e. the non-adhesive side) up against the belt. At this point, the label is stationary up against the belt in the loading section 73 of the label transport. The label transport then conveys the label forwardly to the staging area 74, where the label is stopped. After the label stops in the staging area, the web 33 is advanced to peel the next label from the liner so that it falls to the loading section of the label transport. Now the belt holds two labels. The first label is in the loading section, the second label is in the staging section. The staging sensor 76 detects the leading edge of the label as the label enters the staging section, and sends a signal to the controller 120 indicative of the leading edge of the label. Based on the signals received from the sensor 76, the controller controls the operation of the label transport to advance the label so that the leading edge is positioned at a pre-determined location.

To apply a label to a document, the label is conveyed from the staging area toward the document path. The operation of the document transport and the label transport are controlled to apply the label at a predetermined position along the length of the document. Specifically, sensors along the length of the document path monitor the position of the document as the document is conveyed along the document path. As the document approaches the intersection with the label transport, the controller receives a signal from sensor 106 indicating the presence of the leading edge of the document. The controller 120 then controls the pivoting guide 108 so that the guide pivots toward the label transport 70. In addition, in response to signals that the controller receives regarding the position of the document, the controller controls the label transport, starting the label at the appropriate time so that the leading edge of the label contacts the document as the document passes through the intersection with the label transport.

By controlling the timing of the start of the label transport, the position that the label is applied along the length of the envelope can be controlled. Specifically, the sooner the label transport is started relative to the time the leading edge of the document passes a particular position, the closer the label will be applied to the leading edge of the document. Conversely, delaying the start of the label transport will cause the label to be applied along the document farther from the leading edge of the document. In this way, by controlling the start of the label transport relative to the position of the leading edge of the document, the position that the label is applied along the length of a document may be controlled without varying the speed of the document being conveyed along the document path.

In certain situations, it may be desirable to purge the labels from the label transport without transporting the labels to the document transport. For instance, at the end of a batch of mail, if there are labels on the label transport, the labels should be disposed of. Otherwise, the adhesive may dry out so that they do not adhere to the documents when the next batch of mail is processed. Accordingly, in the present instance, the label transport is operable in a reverse direction so that the labels are discharged into a receptacle 78 adjacent the loading area 74.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A device for applying labels to documents, comprising:
a first transport operable to convey documents along a transport path;
a supply of labels comprising a length of web onto which labels are releasably adhered, wherein each label has a width and a height, such that the width is at least as great as the height;
a label peeler for serially peeling the labels from the web such that the width of the label is a leading edge as the label is peeled from the web; and
a second transport for transporting the labels from the label peeler toward the document path, wherein the transport is configured so that the labels are conveyed with the height of the label being the leading edge.

2. The device of claim 1 wherein the supply of labels is a roll of labels and the labels are adhered to the web so that the width of each label is parallel with the axis of the roll of labels.

3. The device of claim 1 wherein the second transport comprises a vacuum belt operable to apply vacuum to the labels to retain the labels against the belt as the labels are conveyed toward the document path.

4. The device of claim 1 wherein the speed of the second transport and the label transport are controlled so that the labels are conveyed by the label transport at a speed that is substantially similar to the speed at which the documents are conveyed by the second transport.

5. The device of claim 4 comprising a controller operable to control the speed of the second transport so that the speed of the second transport is approximately zero when the label enters the label transport and wherein the second transport is subsequently accelerated to a speed that is substantially similar to the speed at which the documents are conveyed by the first transport.

6-7. (canceled)

8. The device of claim 1 wherein the transport has a length that is sufficient to simultaneously transport two labels.

9. (canceled)

10. The device of claim 1 wherein the label peeler is an elongated element forming an edge and the web is pulled over the edge to peel the labels off the web.

11. The device of claim 1 comprising an intersection between the first transport and the second transport, wherein a label is progressively adhered to a document at the intersection.

12. A method for applying labels to documents, comprising the steps of:
providing a supply of labels comprising a length of web onto which a series of labels are releasably adhered;
conveying the web past a label remover operable to remove the labels from the web, whereby the labels are removed such that a first edge of each label is the leading edge as the labels are removed from the web;
conveying a removed label along a label path, whereby a second edge of the label is the leading edge as the label is conveyed; and
adhering the label to a document as the document is conveyed along a document path.

13. The method of claim 12 wherein the first edge of the label is transverse the second edge of the label.

14. The method of claim 12 wherein the label is applied to the document by first adhering a portion of the label adjacent the second edge.

15. The method of claim 12 wherein the step of conveying the label comprises applying vacuum to the label to retain the label in engagement with a transport belt.

16-17. (canceled)

18. The method of claim 12 wherein the step of conveying the label comprises accelerating the label along the label path until the label is being conveyed at approximately the same speed as document is being conveyed along the document path.

19. The method of claim 12 comprising the step of staging the removed label at a point along the label path after the label is conveyed away from the label remover.

20-29. (canceled)

30. A method for applying labels to documents, comprising the steps of:
conveying a document along a document path;
providing a supply of labels comprising a length of web onto which a series of labels are releasably adhered;
removing a first label from the web;
conveying the first label along a label path to a staging position along the label path;
stopping the first label at the staging position;
advancing the first label from the staging position toward the document path; and
adhering the first label to a document as the document is conveyed along the document path.

31. (canceled)

32. The method of claim 30 comprising the step of removing a second label while the first label is stopped at the staging position.

33. The method of claim 30 wherein the step of removing a label comprises peeling the label from the web.

34. (canceled)

35. The method of claim 30 wherein the step of adhering the label comprises the steps of adhering a leading edge of the label to the document and then progressively adhering the label to the document.

36. The method of claim 30 wherein the step of removing a label comprises peeling the label so that a first edge of the label is the leading edge and the step of conveying the label comprises conveying the label such that a second edge of the label is the leading edge, wherein the second edge of the label is transverse the first edge.

37. The method of claim 30 comprising the steps of winding the web onto a spool after the labels are removed from the web, and collapsing the spool to remove the web from the spool.

38. The method of claim 30 comprising the step of selectively conveying a label in a reverse direction to eject the label away from the document path.
